(19) United States
(12) Patent Application Publication
(10) Pub. No.: US 2024/0050906 A1
(43) Pub. Date: Feb. 15, 2024

(54) CROSSLINKED ION-EXCHANGE MATERIALS, RELATED METHODS, AND RELATED ARTICLES

(71) Applicant: REGENTS OF THE UNIVERSITY OF MICHIGAN, Ann Arbor, MI (US)

(72) Inventors: Jovan Kamcev, Ann Arbor, MI (US); Jose C. Diaz, Ann Arbor, MI (US)

(21) Appl. No.: 18/278,444

(22) PCT Filed: Mar. 4, 2022
(86) PCT No.: PCT/US22/18826

§ 371 Date: Aug. 23, 2023

Related U.S. Application Data
(60) Provisional application No. 63/158,296, filed on Mar. 8, 2021.

(51) Int. Cl. B01D 71/40; B01D 61/44; B01D 69/12

(52) U.S. Cl. CPC B01D 71/4011; B01D 61/44; B01D 69/1214; B01D 2325/42; B01D 2323/30; B01D 2325/04

(57) ABSTRACT

The disclosure relates to crosslinked ion-exchange materials (IEM), related methods of making lEMs, and related articles including IEMs. The IEMs can be formed by providing a reaction solution including a charged vinyl monomer, a polyfunctional vinyl crosslinking monomer, a vinyl polymerization initiator, and water; and then performing vinyl polymerization in the reaction solution to form the IEM as a crosslinked reaction product. The reaction solution contains primarily or only water as a solvent for the vinyl monomers. The resulting crosslinked reaction product has a combination of high ionic-exchange capacity (IEC) values coupled with low water uptake and/or low water mass fraction values, which make it suitable for use in various ion-exchange applications.

### CROSS REFERENCE TO RELATED APPLICATION

Priority is claimed to U.S. Provisional Application No. 63/158,296 filed on Mar. 8, 2021, which is incorporated herein by reference in its entirety.

### STATEMENT OF GOVERNMENT INTEREST

None.

### BACKGROUND OF THE DISCLOSURE

### Field of the Disclosure

The disclosure relates to crosslinked ion-exchange materials (IEM), related methods of making IEMs, and related articles including IEMs. The IEMs can be formed by vinyl polymerization in a reaction solution including a charged vinyl monomer, a polyfunctional vinyl crosslinking monomer, a vinyl polymerization initiator, and water. The resulting crosslinked reaction product has a combination of high ionic-exchange capacity (IEC) values coupled with low water uptake and/or low water mass fraction values, which make it suitable for use in various ion-exchange applications.

### Background

Membranes made from polymers that have ionizable functional groups covalently attached to their backbone (also known as ion-exchange membranes or IEMs) are used in various water treatment applications (e.g., electrodialysis, reverse electrodialysis, membrane-assisted capacitive deionization, etc.) as well as several important energy applications (e.g., fuel cells, vanadium flow batteries, etc.). In all of these technologies, the IEMs must allow fast transport of counter-ions (ions with opposite charge to that of fixed charges) and prevent the crossover of undesirable species. For example, IEMs for electrodialysis must be permeable to counter-ions and impermeable to co-ions (ions with similar charge to that of fixed charges) and water. A throughput/selectivity tradeoff has been recognized for IEMs, where membranes that exhibit fast counter-ion transport (i.e., higher throughput) tend to be less selective than membranes that exhibit lower counter-ion transport.

The two most important membrane characteristics that influence IEM transport properties are charge density and water uptake. Higher charge densities promote faster counter-ion transport and better exclusion of co-ions, which leads to higher selectivities. Higher water uptake effectively decreases the charge density, all other factors being equal, and promotes higher co-ion transport, which leads to lower selectivities. Thus, to overcome the throughput/selectivity tradeoff, the membrane charge density must be high and water uptake must be low. Membrane charge density and water uptake in IEMs made from linear polymers are typically coupled, where higher charge densities lead to higher water uptake since the polymer becomes more hydrophilic. Cross-linked polymer networks, in which the polymer chains are chemically bonded, allow independent control of membrane water uptake by controlling the polymer cross-link density. Nearly all commercial IEMs for electrodialysis are made from cross-linked polymers.

Traditionally, cross-linked IEMs have been synthesized via a multiple-step procedure. In general, the first step involves synthesizing a neutral cross-linked network, and the second step involves functionalizing the cross-linked network with ionizable groups. More recently, cross-linked IEMs have been synthesized via a one-step procedure, in which a charged monomer is reacted with a neutral cross-linker in a common solvent to afford a cross-linked IEM. Higher charge densities can be attained by incorporating more charged monomer into the network, and lower water uptake can be attained by increasing the cross-link density. A challenge with the one-step procedure is finding an appropriate solvent that can dissolve large amounts of the charged monomer and neutral cross-linker. This is difficult because the charged monomers are very hydrophilic, and the cross-linkers are typically hydrophobic. Consequently, commercial cross-linked IEMs are typically limited to certain ranges of charge densities and water uptake.

Brine management is difficult when treating water sources such as brackish water, seawater, municipal and industrial wastewater. Conventional membrane, thermal, and crystallization methods are typically limited by one or more of cost, energy, and pressure considerations.

Electrodialysis provides a lower energy alternative to thermal brine concentration. Electrodialysis operates at low pressures and has low fouling/scaling propensity during brine treatment. The majority of commercial IEMs were designed for brackish water desalination, however, and are thus not suitable for treating brines via electrodialysis. Conventional IEMs essentially lose their charge when contacted by highly concentrated salt solutions, which ultimately results in low membrane selectivity.

U.S. Publication No. 2013/0064982 is directed to cation exchange materials prepared in an aqueous solution including both water and a water-soluble alcohol. The aqueous water/alcohol solution is mixed with a vinyl-based monomer having a sulfonic acid functional group, a bifunctional vinyl-based cross-linking agent, and a polymerization initiator to form a reaction solution. The monomer and the cross-linking agent are then polymerized.

### SUMMARY

The disclosure provides a method for forming crosslinked IEMs in which highly charged IEMs having low water uptake values can be synthesized via a one-step procedure. The method utilizes inexpensive, commercially available charged monomers and cross-linkers, and the reaction is carried out in water under relatively mild conditions, generally without the need for solvents other than water. The method can be used to form IEM membrane materials, and the membrane fabrication process can be scaled up with existing membrane roll-to-roll manufacturing infrastructure. The membranes according to the disclosure are useful for various water treatment and energy technologies, particularly electrodialysis and reverse electrodialysis with highly concentrated salt solutions (e.g., brines). The membranes can exhibit both fast counter-ion transport and high permselectivity, which would increase the efficiency and decrease the energy costs of current technologies and enable their cost-effective use in applications such as the treatment of brines via electrodialysis.

In an aspect, the disclosure relates to a method for forming a crosslinked ion-exchange material (IEM), the method comprising: providing a reaction solution comprising: a charged vinyl monomer, a polyfunctional vinyl crosslinking monomer, a vinyl polymerization initiator, and water, wherein the reaction solution is substantially free from monomer solvents other than water; and performing vinyl polymerization in the reaction solution between at least the charged vinyl monomer and the polyfunctional vinyl crosslinking monomer, thereby forming a crosslinked ion-exchange material (IEM) reaction product.

In another aspect, the disclosure relates to a method for forming a crosslinked ion-exchange material (IEM), the method comprising: providing a reaction solution comprising: a charged vinyl monomer, a polyfunctional vinyl crosslinking monomer, a vinyl polymerization initiator, and water, wherein a combined amount of all vinyl monomers, all vinyl polymerization initiators, and water in the reaction solution is at least 96 wt. %, 98 wt. %, 99 wt. % relative to the reaction solution; and performing vinyl polymerization in the reaction solution between at least the charged vinyl monomer and the polyfunctional vinyl crosslinking monomer, thereby forming a crosslinked ion-exchange material (IEM) reaction product.

In another aspect, the disclosure relates to a crosslinked ion-exchange material (IEM) formed by any of the foregoing methods according to their various embodiments or refinements.

In another aspect, the disclosure relates to a crosslinked ion-exchange material (IEM) comprising a crosslinked reaction product between a charged vinyl monomer and a polyfunctional vinyl crosslinking monomer; wherein the crosslinked reaction product has one, two, three, four, or five of the following properties: (a) an ion-exchange capacity (IEC) of at least 1 mmol/g(dry polymer); (b) a water-uptake of at most 0.7 g(water)/g(dry polymer); (c) a ratio of an ion-exchange capacity (IEC) relative to water mass fraction of at least 6 (mmol·g(wet polymer))/(g (dry polymer)·g(water)); (d) a water mass fraction of at most 0.45 g(water)/g(wet polymer); and (e) a charge concentration of at least 4.5 mmol/g(water).

In another aspect, the disclosure relates to a backed membrane article comprising: a solid support material; and a crosslinked IEM according to any of the variously disclosed embodiments or refinements adhered to the solid support material.

In another aspect, the disclosure relates to an electrodialysis apparatus comprising a crosslinked IEM or a backed membrane article according to any of the variously disclosed embodiments or refinements as a separation membrane. More generally, technologies that can benefit from the disclosed materials include electrodialysis, reverse electrodialysis, diffusion dialysis, capacitive de-ionization, electrolysis, fuel cells, and flow batteries. Accordingly, in other aspects, the disclosure relates to apparatus selected from the group consisting of an electrodialysis apparatus, a reverse electrodialysis apparatus, a diffusion dialysis apparatus, a capacitive de-ionization apparatus, an electrolysis apparatus, a fuel cell apparatus, and a flow battery apparatus, the apparatus comprising a crosslinked IEM or a backed membrane article according to any of the variously disclosed embodiments or refinements as a component thereof.

In another aspect, the disclosure relates to a composite membrane article comprising a porous substrate defining pores therein and a crosslinked IEM according to any of the variously disclosed embodiments or refinements inside the pores of the porous substrate and adhered to the porous substrate.

Various refinements of the IEMs, related methods, and related articles are possible.

In a refinement, a combined amount of all vinyl monomers and water in the reaction solution is at least 95 wt. %, 98 wt. %, or 99 wt. % relative to the reaction solution. In a further refinement, the foregoing ranges can apply to the combined amount of all vinyl monomers, all vinyl polymerization initiators, and water in the reaction solution.

In a refinement, a combined amount of all vinyl monomers in the reaction solution is in a range of 80 wt. % to 95 wt. % relative to the reaction solution.

In a refinement, the charged vinyl monomer is present in the reaction solution in an amount in a range of 40 wt. % to 70 wt. %; the polyfunctional vinyl crosslinking monomer is present in the reaction solution in an amount in a range of 20 wt. % to 55 wt. %; a weight ratio of charged vinyl monomer relative to polyfunctional vinyl crosslinking monomer in the reaction solution is in a range of 0.33 to 3.0; the vinyl polymerization initiator is present in the reaction solution in an amount in a range of 0.01 wt. % to 5 wt. %; and/or the water is present in the reaction solution in an amount in a range of 5 wt. % to 25 wt. %.

In a refinement, the reaction solution contains less than 4 wt. %, 2 wt. %, or 1 wt. % of monomer solvents other than water.

In a refinement, the charged vinyl monomer has one polymerizable vinyl group and comprises at least one of a sulfonate group, a carboxylate group, and an ammonium group.

In a refinement, the charged vinyl monomer is represented by formula (I): R¹—C(═CH₂)—C(═O)—X—R²—Y (I). R¹ is hydrogen (H) or a hydrocarbon group having 1-4 carbon atoms (e.g., substituted or unsubstituted alkyl); R² is a hydrocarbon group having 1-12 carbon atoms (e.g., substituted or unsubstituted alkylene, substituted or unsubstituted arylene); X is oxygen (O) or an amino group represented by NR³; R³ is hydrogen (H) or a hydrocarbon group having 1-4 carbon atoms (e.g., substituted or unsubstituted alkyl); and Y is a charged group selected from the group consisting of a sulfonate group, a carboxylate group, and an ammonium group.

In a refinement, the polyfunctional vinyl crosslinking monomer has two polymerizable vinyl groups.

In a refinement, the polyfunctional vinyl crosslinking monomer is represented by formula (III): R¹—C(═CH₂)—C(═O)—X—R²—X—C(═O)—C(═CH₂)—R¹ (III). R¹ is hydrogen (H) or a hydrocarbon group having 1-4 carbon atoms (e.g., substituted or unsubstituted alkyl); R² is a hydrocarbon group having 1-16 carbon atoms (e.g., substituted or unsubstituted alkylene, substituted or unsubstituted arylene); X is oxygen (O) or an amino group represented by NR³; and R³ is hydrogen (H) or a hydrocarbon group having 1-4 carbon atoms (e.g., substituted or unsubstituted alkyl).

In a refinement, the polyfunctional vinyl crosslinking monomer comprises a (pendant) hydroxy group.

In a refinement, the vinyl polymerization initiator comprises a free-radical-generating azo compound.

In a refinement, providing the reaction solution comprises: providing a pre-solution comprising: the charged vinyl monomer, and the water, wherein the pre-solution is substantially free from monomer solvents other than water (e.g., and also substantially free from the polyfunctional vinyl crosslinking monomer); and adding the polyfunctional vinyl crosslinking monomer and the vinyl polymerization initiator to the pre-solution to form the reaction solution. In further refinements, the charged vinyl monomer is present in the pre-solution in an amount in a range of 50 wt. % to 90 wt. %; the water is present in the pre-solution in an amount in a range of 10 wt. % to 50 wt. %; the pre-solution contains less than 1 wt. % of monomer solvents other than water; and/or the pre-solution contains less than 1 wt. % of polyfunctional vinyl crosslinking monomers. In a further refinement, a combined amount of all vinyl charged monomers and water in the pre-solution is at least 95 wt. % relative to the pre-solution.

In a refinement, the IEM reaction product is in the form of a thin film or membrane.

In a refinement, the method further comprises performing the vinyl polymerization with the reaction solution in the presence of a solid support material, thereby forming the crosslinked IEM reaction product adhered to the solid support material, for example to provide the final crosslinked IEM reaction product in the form of a membrane with suitable backing. The solid support material can have a thickness in a range of 2 μm to 600 μm.

In a further refinement, the solid support material comprises a porous substrate defining pores therein; and the crosslinked IEM reaction product is inside the pores of the porous substrate and adhered to the porous substrate. The porous substrate can comprise a microporous membrane. The microporous membrane can have a porosity in a range of 30% to 70%. The microporous membrane can have a pore size in a range of 0.03 μm to 1 μm. The microporous membrane can comprise a polymer selected from the group consisting of polypropylene, polyethylene, polytetrafluoroethylene, and combinations thereof. The microporous membrane can have a thickness in a range of 2 μm to 20 μm or 50 μm to 200 μm.

In a refinement, the crosslinked (IEM) reaction product has an ion-exchange capacity (IEC) of at least 1 mmol/g(dry polymer).

In a refinement, the crosslinked (IEM) reaction product has a water-uptake of at most 0.7 g(water)/g(dry polymer).

In a refinement, the crosslinked (IEM) reaction product has a water mass fraction of at most 0.45 g(water)/g(wet polymer).

In a refinement, the crosslinked (IEM) reaction has a ratio of an ion-exchange capacity (IEC) relative to water mass fraction of at least 6 (mmol·g(wet polymer))/(g (dry polymer)·g (water)).

In a refinement, the crosslinked (IEM) reaction product has a charge concentration of at least 4.5 mmol/g(water).

While the disclosed compounds, methods, and compositions are susceptible of embodiments in various forms, specific embodiments of the disclosure are illustrated (and will hereafter be described) with the understanding that the disclosure is intended to be illustrative, and is not intended to limit the claims to the specific embodiments described and illustrated herein.

### BRIEF DESCRIPTION OF THE FIGURES

FIG. 1 illustrates a representative method for forming a crosslinked ion-exchange material (IEM) according to the disclosure.

FIG. 2 illustrates representative charged vinyl monomers and polyfunctional vinyl crosslinking monomers that can be used according to the disclosure.

FIG. 3 illustrates a crosslinked ion-exchange material (IEM) reaction product according to the disclosure, in the particular form of a membrane or film including an optional solid support.

FIG. 4 illustrates a crosslinked ion-exchange material (IEM) reaction product according to the disclosure, in the particular form of a composite membrane article including a porous substrate solid support.

### DETAILED DESCRIPTION

The disclosure relates to crosslinked ion-exchange materials (IEMs), corresponding methods for making IEMs, and corresponding articles including IEMs. The different components of a typical reaction to form crosslinked ion-exchange material (IEM) include a charged vinyl monomer (or just “charged monomer”), a polyfunctional vinyl crosslinking monomer (or just “crosslinking monomer”), solvent, and initiator. The charge density of a corresponding membrane formed from the IEM is controlled by the amount of charged vinyl monomer in the reaction mixture. The membrane water uptake is controlled by the effective crosslink density, which is affected by the amount of polyfunctional vinyl crosslinking monomer and solvent in the reaction mixture. High membrane charge densities and low water uptake values can be attained when (i) large amounts of charged monomer and crosslinking monomer and (ii) small amounts of solvent are used. Water is a preferred solvent for this reaction because it is an excellent solvent for the charged monomer, and it is non-toxic and widely available. However, typical crosslinking monomers are hydrophobic and scarcely soluble in water.

It has been found, however, in the methods according to the disclosure that the crosslinking monomer is soluble in/miscible with a solution of the charged monomer in water, thus allowing the preparation of an initial reaction solution in which all the monomer components are dissolved in a continuous, homogeneous, single-phase liquid reaction medium without the need for including an additional co-solvent (e.g., an organic or other water-miscible solvent such as a lower alcohol) for the dissolution of the crosslinking monomer. Elimination of such additional monomer solvents can provide several benefits, for example reduced cost, reduced toxicity, and/or reduced environmental impact that would otherwise be associated with the solvents.

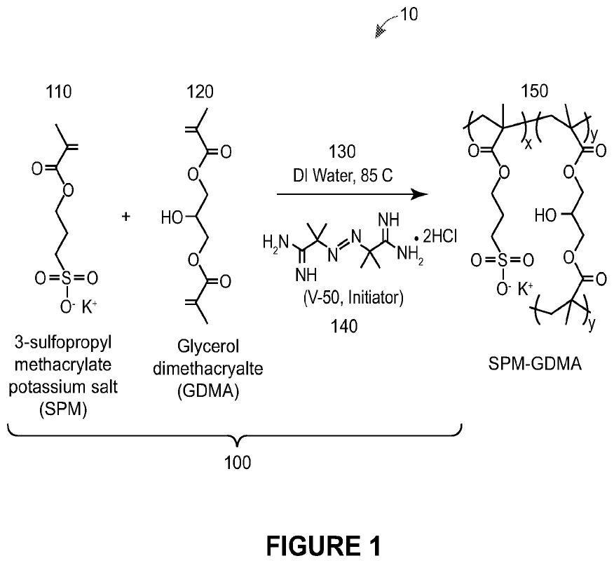

FIG. 1 illustrates a representative method 10 for forming a crosslinked ion-exchange material (IEM) 150 according to the disclosure. An initial reaction solution 100 is formed that includes a charged vinyl monomer 110, a polyfunctional vinyl crosslinking monomer 120, water 130, and vinyl polymerization initiator 140. The reaction solution 100 is a single-phase liquid reaction medium in which the vinyl monomers 110, 120, water 130, and initiator 140 are dissolved in a continuous, homogeneous reaction mixture. FIG. 1 illustrates 3-sulfopropyl methacrylate potassium salt (SPM) as a representative charged vinyl monomer 110, glycerol dimethacrylate (GDMA) as a representative polyfunctional vinyl crosslinking monomer 120, 2,2′-azobis(2-methylpropionamidine)dihydrochloride (V-50) as a representative vinyl polymerization initiator 140, and a crosslinked SPM-GDMA copolymer as a representative crosslinked IEM 150. Other suitable materials for the various reaction solution 100 components are described in more detail below.

The reaction solution 100 according to the disclosure suitably uses primarily or only water 130 as a liquid solvent for the monomer 110, 120 and initiator 140 components. For example, a combined amount of all vinyl monomers and water in the reaction solution can be at least 95, 96, 97, 98, or 99 wt. % and/or up to 98, 99, or 100 wt. % relative to the reaction solution. Alternatively or additionally, a combined amount of all vinyl monomers, all vinyl polymerization initiators, and water in the reaction solution can be at least 95, 96, 97, 98, or 99 wt. % and/or up to 98, 99, or 100 wt. % relative to the reaction solution. In various embodiments, the water can be present in the reaction solution in an amount in a range of 5 wt. % to 25 wt. %, for example in an amount of at least 5, 7, 10, 12, or 15 wt. % and/or up to 12, 15, 20, or 25 wt. %.

The reaction solution 100 according to the disclosure can be free or substantially free from monomer solvents other than water. For example, in some embodiments, the reaction solution can contain less than 4, 3, 2, 1, or 0.1 wt. % and/or at least 0.01 or 0.1 wt. % of monomer solvents other than water. While monomer solvents other than water are suitably avoided, in some embodiments it can be desirable to include minor amounts of monomer solvents other than water to improve the solubility of the polyfunctional vinyl crosslinking monomer 120, for example at levels of at least 0.01 or 0.1 wt. % and/or up to 1, 2, 3, or 4 wt. % relative to the reaction solution. This can be the case, for example, when the charged vinyl monomer 110 is in an acid form (e.g., having a sulfonic acid or carboxylic acid group). In some embodiments when the charged vinyl monomer 110 is in a salt form, in particular having a metal sulfonate or metal carboxylate group (e.g., potassium or sodium), the water 130 is suitably the only monomer solvent. The monomer solvents other than water generally include any solvent, typically miscible with water, that can dissolve/solubilize the crosslinking monomer. Examples include water-soluble alcohols, such as alcohols having 1-6 carbon atoms. Specific examples include methanol, ethanol, (n- or iso-)propanol, (n-, sec-, or tert-)butanol, etc. Other examples include water-soluble organic solvents or water-soluble polar aprotic solvents such as dimethylformamide (DMF), dimethyl sulfoxide (DMSO), N-methyl-2-pyrrolidone (NMP), tetrahydrofuran (THF), acetone, etc. In various embodiments, the reaction solution can contain specific solvents or general solvent classes (e.g., 1-propanol or water-soluble alcohols) at levels less than the foregoing thresholds and/or within the foregoing ranges.

A vinyl polymerization reaction is performed in the reaction solution 100 between the charged vinyl monomer 110 and the polyfunctional vinyl crosslinking monomer 120 to form the corresponding IEM reaction product 150 as a crosslinked copolymer between the vinyl monomers 110, 120. The vinyl polymerization reaction is typically thermally initiated by heating the reaction solution 100 which contains the vinyl polymerization initiator 140 to initiate and propagate free-radical polymerization between the vinyl monomers 110, 120. In some embodiments the vinyl polymerization reaction can be photochemically initiated by irradiating the reaction solution 100. The reaction can be performed at any suitable time/temperature selection, for example at a temperature in a range of 50° C. to 95° C., such as at least 50, 60, 70, or 80° C. and/or up to 80, 90, or 95° C., and/or for a reaction time in a range of 10 min to 360 min, such as at least 10, 20, 30, 40, or 60 min and/or up to 60, 120, 240, or 360 min.

The charged vinyl monomer 110 generally includes at least one polymerizable vinyl group (>C═C<) and at least one charged group such as a sulfonate group, carboxylate group, or an ammonium group. For example, the charged vinyl monomer 110 can include one, two, or more than two polymerizable vinyl groups and/or one, two, or more than two charged groups. Suitably, the charged vinyl monomer 110 includes only one polymerizable vinyl group, which permits the monomer to contribute to polymeric chain growth, but not crosslinking. In some embodiments, the charged vinyl monomer 110 includes two or polymerizable vinyl groups, which permits the monomer to contribute to both polymeric chain growth and crosslinking. In some embodiments, multiple charged vinyl monomers 110 can be included in the reaction solution 100, for example with the different monomers 110 having the same or different number of polymerizable vinyl groups and/or charged groups. The charged vinyl monomer 110 can be present in the reaction solution 100 in an amount in a range of 25 wt. % to 70 wt. % or 40 wt. % to 70 wt. %, for example at least 25, 30, 35, 40, 45, 50, or 55 wt. % and/or up to 40, 45, 50, 55, 60, 65, or 70 wt. %. The foregoing ranges can apply to individual charged vinyl monomers 110 or the combined amount of all charged vinyl monomers 110 in the reaction solution 100.

The vinyl group(s) and the charged group(s) in the charged vinyl monomer 110 can be joined by a suitable linking group, for example a hydrocarbon group having 1-12 carbon atoms, such as at least 1, 2, 3, 4, or 6 and/or up to 4, 6, 8, 10, or 12 carbon atoms. Examples of suitable hydrocarbon groups include alkyl moieties (e.g., linear, branched, or cyclic alkyl), aryl or aromatic moieties, and/or heteroaryl or heteroaromatic groups. The linking group can further include one or more groups such as ester groups, amide groups, hydroxy groups, amino groups, etc. that can be part of the link between the vinyl group and the charged group and/or side-chain substituents thereon. The sulfonate group can be in acid or salt form, for example being represented by —SO₃H or —SO₃M, such as where M is a metal cation such as Na, K, or other alkali metal. The carboxylate group can be in acid or salt form, for example being represented by —CO₂H or —CO₂M, such as where M is a metal cation such as Na, K, or other alkali metal. The ammonium group can be in salt form, for example being represented by —N(R^{a}R^{b}R^{c})X, such as where X is an anion such as F, Cl, or other halogen; R^{a}, R^{b}, and R^{c} are independently substituted or unsubstituted alkyl groups, for example having 1-4 carbon atoms, such as methyl, ethyl, (iso)propyl, etc.

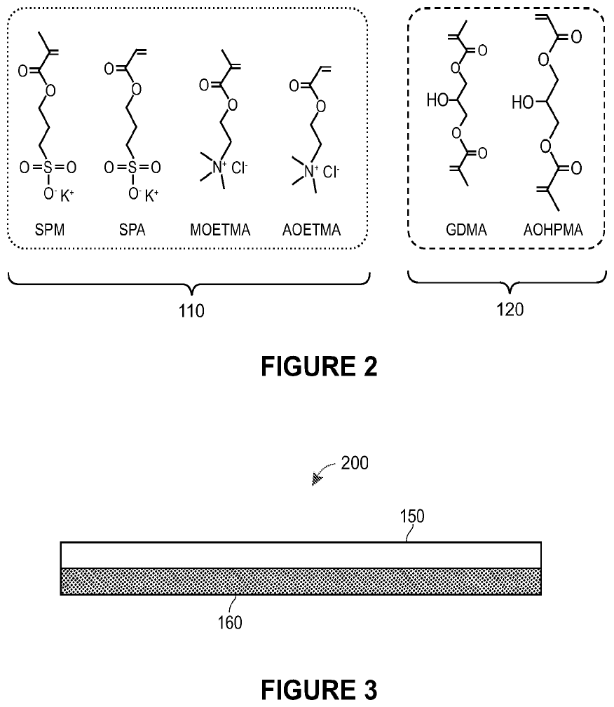

The charged vinyl monomer 110 more generally can be an acrylic-based monomer, a styrene-based monomer or an allyl-based monomer. Examples of suitable charged monomers with sulfonate groups include styrene sulfonic acid, methylallyl sulfonic acid, vinyl sulfonic acid, allyl sulfonic acid, 2-acrylamido-2-methyl propane sulfonic acid (AMPS), acid 2-sulfoethyl (meth)acrylate, acid 3-sulfopropyl (meth)acrylate, and salts thereof (e.g., sodium or potassium salts thereof). Examples of suitable charged monomers with ammonium groups include 2-(trimethylammonium)ethyl (meth)acrylate, for example chloride or other halogen salts thereof, [3-(methacryloyl amino)propyl] trimethyl ammonium chloride, (3-acrylamido propyl) trimethylammonium chloride, and (vinylbenzyl)trimethylammonium chloride. FIG. 2 illustrates the chemical structures of some representative charged vinyl monomers 110, including 3-sulfopropyl methacrylate potassium salt (SPM), 3-sulfopropyl acrylate potassium salt (SPA), [2-(methacryloyloxy)ethyl] trimethylammonium chloride (MOETMA), and [2-(acryloyloxy)ethyl] trimethylammonium chloride (AOETMA).

In some embodiments, the charged vinyl monomer 110 can be represented by the generic formula (I): R¹—C(═CH₂)—C(═O)—X—R²—Y (I), where C(═CH₂) represents the polymerizable vinyl group and Y represents the charged group. In various embodiments, R¹ can be hydrogen (H) or a hydrocarbon group having 1, 2, 3, or 4 carbon atoms, for example a substituted or unsubstituted alkyl group. In various embodiments, R² can be a hydrocarbon group having 1-12 carbon atoms, such as a substituted or unsubstituted alkylene, a substituted or unsubstituted arylene, etc. Examples of suitable R² groups include alkyl moieties (e.g., linear, branched, or cyclic alkyl), aryl or aromatic moieties, and/or heteroaryl or heteroaromatic groups, for example with at least 1, 2, 3, 4, or 6 and/or up to 4, 6, 8, 10, or 12 carbon atoms. In various embodiments, X can be oxygen (O) or an amino group represented by NR³, where R³ is hydrogen (H) or a hydrocarbon group having 1, 2, 3, or 4 carbon atoms (e.g., substituted or unsubstituted alkyl). In various embodiments, Y can be a charged group such as a sulfonate group, a carboxylate group, or an ammonium group as described above. In some embodiments, the formula (I) can represent a (meth)acrylate-based charged monomer with X═0 and R¹═H (acrylate) or R¹═CH₃ (methacrylate)). Similarly, the formula (I) can represent a (meth)acrylamide-based charged monomer with X═NH (or NR³) and R¹═H (acrylamide) or R¹═CH₃ (methacrylamide)). In another embodiment, the charged vinyl monomer 110 need not include an acrylate or acrylamide functionality, but it analogously can be represented by formula (II): R¹—C(═CH₂)—R²—Y (II) with the same definitions as above, for example to represent an allyl-based or styrene-based charged monomer.

The polyfunctional vinyl crosslinking monomer 120 generally includes at least two polymerizable vinyl group (>C═C<). Suitably, the polyfunctional vinyl crosslinking monomer 120 includes only two polymerizable vinyl groups, which permits the monomer to contribute to polymeric chain growth and crosslinking. In some embodiments, the polyfunctional vinyl crosslinking monomer 120 includes three or more polymerizable vinyl groups, which permits the monomer to provide a higher degree of crosslinking in the final IEM 150. In some embodiments, multiple polyfunctional vinyl crosslinking monomer 120 can be included in the reaction solution 100, for example with the different monomers 120 having the same or different number of polymerizable vinyl groups. The polyfunctional vinyl crosslinking monomer 120 can be present in the reaction solution 100 in an amount in a range of 20 wt. % to 65 wt. % or 20 wt. % to 55 wt. %, for example at least 20, 25, 30, 35, or 40 wt. % and/or up to 30, 35, 40, 45, 50, 55, 60, or 65 wt. %. The foregoing ranges can apply to individual crosslinking monomers 120 or the combined amount of all crosslinking monomers 120 in the reaction solution 100.

The vinyl groups in the polyfunctional vinyl crosslinking monomer 120 can be joined by a suitable linking group, for example a hydrocarbon group having 1-16 carbon atoms, such as at least 1, 2, 3, 4, or 6 and/or up to 4, 6, 8, 10, 12, or 16 carbon atoms. Examples of suitable hydrocarbon groups include alkyl moieties (e.g., linear, branched, or cyclic alkyl), aryl or aromatic moieties, and/or heteroaryl or heteroaromatic groups. The linking group can further include one or more groups such as ester groups, amide groups, hydroxy groups, amino groups, etc. that can be part of the link between the vinyl groups and/or side-chain substituents thereon. In a particular embodiment, the polyfunctional vinyl crosslinking monomer 120 contains at least one (e.g., 1, 2, 3, or more) hydroxy group (—OH), for example as a pendant group or other substituent on the linking group or hydrocarbon group. Without being bound by a particular theory, it is believed that the presence of a relatively polar hydroxy group on the crosslinking monomer 120 in an otherwise relatively hydrophobic molecule can promote compatibility with the water 130 and the charged vinyl monomer 110 to provide the homogeneous reaction solution 100 without the inclusion of an alcohol or other non-water monomer solvent.

The polyfunctional vinyl crosslinking monomer 120 may be an acrylic-based crosslinking monomer, a styrene-based crosslinking monomer, or an allyl-based crosslinking monomer. Examples include glycerol dimethacrylate (GDMA), N-(acrylamidomethyl)methacrylamide, ethyleneglycol dimethacrylate, glycerol diacrylate, glycerol acrylate-methacrylate (AOHPMA), poly(ethyleneglycol)dimethacrylate, glycerol 1,3-diglycerolate diacrylate (GDDA), and methylenebisacrylamide. FIG. 3 illustrates the chemical structures of some representative crosslinking monomers 120, including GDMA and AOHPMA, both of which incorporate a pendant hydroxy group along their linking/hydrocarbon group between vinyl groups.

In some embodiments, the polyfunctional vinyl crosslinking monomer 120 can be represented by the generic formula (III): R¹—C(═CH₂)—C(═O)—X—R²—X—C(═O)—C(═CH₂)—R¹ (III), where the C(═CH₂) groups represent the polymerizable vinyl groups. R¹, R², and X can be as defined above for formula (I), except that R² can have at least 1, 2, 3, 4, or 6 and/or up to 4, 6, 8, 10, 12, or 16 carbon atoms in some embodiments. In a particular embodiment, the R² group contains at least one (e.g., 1, 2, 3, or more) hydroxy group (—OH), for example as a pendant group or other substituent on the corresponding hydrocarbon chain of R². In some embodiments, the formula (III) can represent a (meth)acrylate-based crosslinking monomer with X═O and R¹═H (acrylate) or R¹═CH₃ (methacrylate)). Similarly, the formula (III) can represent a (meth)acrylamide-based crosslinking monomer with X═NH (or NR³) and R¹═H (acrylamide) or R¹═CH₃ (methacrylamide)). The glycerol-based di(meth)acrylates are represented by X═O and R²═CH₂—CH(OH)—CH₂ (i.e., a 2-hydroxy-substituted C₃ alkylene group). Although illustrated as symmetric, the X and R¹ groups on one side of the R² group in formula (III) can be the same or different as the X and R¹ groups on the other side of the R² group in formula (III) (i.e., but still selected within the same general range of options). In another embodiment, the crosslinking monomer 120 need not include an acrylate or acrylamide functionality, but it can be analogously represented by formula (IV): R¹—C(═CH₂)—R²—C(═CH₂)—R¹ (IV) with the same definitions as above, for example to represent an allyl-based or styrene-based crosslinking monomer.

The reaction solution 100 generally has a relatively high concentration of total vinyl monomers 110, 120, which in turn permits the formation of IEMs 150 having a desirable combination of high IEC values coupled with low water uptake and/or low water mass fraction values. In some embodiments, the combined amount of all vinyl monomers 110, 120 in the reaction solution 100 is in a range of 80 wt. % to 95 wt. % relative to the reaction solution 100, for example being at least 80, 85, or 90 wt. % and/or up to 85, 90, 92, or 95 wt. %. The reaction solution 100 alternatively or additionally can be characterized by the relative ratio between the vinyl monomers 110, 120, which ratio suitably can be selected to control the ionic- and water-based properties of the final IEM 150. In some embodiments, the weight ratio of charged vinyl monomer 110 relative to polyfunctional vinyl crosslinking monomer 120 in the reaction solution 100 is in a range of 0.33 to 3.0, for example being at least 0.33, 0.4, 0.5, 0.67, 0.75, 1, 1.25, 1.33, 1.5, or 2 and/or up to 0.5, 0.67, 0.75, 1, 1.25, 1.33, 1.5, 2, 2.5, or 3, where a value above 1 represents a higher relative amount of total charged vinyl monomers 110 compared to total crosslinking monomers 120.

The polymerization of the charged vinyl monomer 110 and the polyfunctional vinyl crosslinking monomer 120 can be initiated using a vinyl polymerization initiator 140 which is soluble in the aqueous reaction solution 100, for example inducing free-radical polymerization upon application of heat (thermal initiation), light (photochemical initiation), etc. The term “vinyl polymerization initiator” indicates that the initiator initiates polymerization between vinyl group-containing monomers, and not necessarily that the initiator itself contains a vinyl group. The initiator can be included in the aqueous reaction solution in any suitable amount, for example at least 0.01, 0.02, 0.05, 0.1, 0.2, or 0.5 wt. % and/or up to 0.2, 0.4, 0.6, 0.8, 1, 1.5, 2, 3, 4, or 5 wt. %. Free radical-generating azo compounds can be suitable initiators, for example including 2,2′-azobis(2-methylpropionamidine)dihydrochloride (commercially known as V-50); 2,2′-azobis[2-(2-imidazolin-2-yl)propane]dihydrochloride (VA-044); 2,2′-azobis[2-(2-imidazolin-2-yl)propane]disulfate dehydrate (VA-046B); 2,2′-azobis[N-(2-carboxyethyl)-2- methylpropionamidine]hydrate (VA-057); 2,2′-azobis{2-[1-(2-hydroxyethyl)-2-imidazolin-2-yl]propane}dihydrochloride (VA-060); 2,2′-azobis[2-(2-imidazolin-2-yl)propane] (VA-061); 2,2′-azobis(1-imino-1-pyrrolidino-2-ethylpropane)dihydrochloride; 2,2′-azobis{2-methyl-N-[1,1-bis(hydroxymethyl)-2-hydroxyethyl]propionamide} (VA-080); 2,2′-azobis[2-methyl-N-(2-hydroxyethyl)propionamide] (VA-086); 4,4′-azobis(4-cyanovaleric acid) (V-501); 4,4′-azobis(4-cyanopentanoicacid)polyethyleneglycolpolymer (VPE-0201); 2,2′-azobis[2-(5-methyl-2-imidazolin-2-yl)propane]dihydrochloride (VA-041); 2,2′-azobis[2-(3,4,5,6-tetrahydropyrimidin- 2-yl)propane] dihydrochloride (VA-058); or 2,2′-azobis{2-methyl-N-[2-(1-hydroxybuthyl)]propionamide} (VA-085). Initiators other than azo compounds can be used, in particular those that have sufficient water solubility to be solubilized in the reaction solution. For example, persulfate initiators such as potassium, sodium, and ammonium persulfates can be used. Peroxide initiators often do not dissolve well in an aqueous environment, but they can be used if solubilized in the reaction solution, for example if including a small amount of a monomer solvent other than water. An example of a suitable peroxide initiator is benzoyl peroxide.

In some embodiments, it can be desirable to mix the charged vinyl monomer 110 and the water 130 to for a pre-solution before adding the polyfunctional vinyl crosslinking monomer 120 and initiator 140. As described above, the crosslinking monomer 120 is generally insoluble in water, but it is soluble in a concentrated pre-solution that contains primarily the charged vinyl monomer 110 and minor amounts of water 130. The charged monomer vinyl monomer 110 is generally highly soluble in water, for example having a solubility in water of at least about 3 or 4 g charged monomer/g water and/or up to 4.5, 5, 6, 7, or 8 g charged monomer/g water. The organic character of the charged monomer 110 provides compatibility with the hydrophobic crosslinking monomer 120 such that the crosslinking monomer 120 can be easily dissolved in the pre-solution without the use of an organic co-solvent for the crosslinking monomer 120. Suitably, the pre-solution can be formed with mild heating while mixing, for example at a temperature from 30° C. to 55° C. or 40° C. to 50° C., to facilitate dissolution of the charged vinyl monomer 110 in the water 130. Such mild heating temperatures are used to avoid undesirable (early) thermal initiation and polymerization of the charged vinyl monomer 110 prior to addition of the crosslinking monomer 120 and initiator 140 for full crosslinking polymerization. Once the pre-solution is formed with the charged vinyl monomer 110 fully solubilized in the water 130, the crosslinking monomer 120 and initiator 140 can be added to the pre-solution, for example with mixing, to form the reaction solution 100. The reaction solution 100 can remain as a stable, homogenous mixture with its components in solution at ambient temperatures (e.g., 20° C. to 25° C. or 20° C. to 30° C.) until it is desired to initiate the vinyl polymerization reaction and form the crosslinked IEM reaction product 150.

In some embodiments, the charged vinyl monomer 110 is present in the pre-solution in an amount in a range of 50 wt. % to 90 wt. %, for example at least 50, 60, or 70 wt. % and/or up to 70, 80, or 90 wt. %. In some embodiments, the water is present in the pre-solution in an amount in a range of 10 wt. % to 50 wt. %, for example at least 10, 20, or 30 wt. % and/or up to 30, 40, or 50 wt. %. In some embodiments, the pre-solution is free or substantially free from monomer solvents other than water, for example containing less than 4, 3, 2, 1, or 0.1 wt. % of monomer solvents other than water. In some embodiments, the pre-solution is free or substantially free from polyfunctional vinyl crosslinking monomers 130 and/or initiators 140, for example containing less than 4, 3, 2, 1, or 0.1 wt. % of monomers 130 and/or initiators 140. In some embodiments, the combined amount of all vinyl charged monomers 110 and water 130 in the pre-solution is at least 95, 96, 97, 98, or 99 wt. % and/or up to 98, 99, or 100 wt. % relative to the pre-solution.

While the formation of the pre-solution prior to forming the reaction solution 100 is often desirable to quickly and efficiently form the reaction solution, it is not required to form the pre-solution. In some embodiments, the vinyl monomers 110, 120, the water 130, and (optionally) the initiator 140 can be combined at the same time and simply mixed for a sufficient amount of time, for example with some mild heating as above, until the components form a homogenous mixture in solution. This approach can require a longer mixing time to form the reaction solution 100 as compared to a method that initially forms the pre-solution, but it is otherwise a suitable method to form the reaction solution 100. In some embodiments, the initiator 140 can be initially combined with the vinyl monomers 110, 120 and the water 130, or it can be added to the components after mixing, for example just before initiation of the vinyl polymerization reaction.

The crosslinked IEM reaction product 150 is suitably in the form of a thin film or membrane, which in turn makes it useful as an ion-exchange membrane in a variety of conventional applications, for example water treatment applications (e.g., electrodialysis, reverse electrodialysis, membrane-assisted capacitive deionization, etc.) as well as several important energy applications (e.g., fuel cells, vanadium flow batteries, etc.). The IEM reaction product can be formed as a thin film using any suitable method, for example by placing a thin layer of liquid reaction solution between two plates spaced apart by the desired eventual film thickness, and then performing the vinyl polymerization to form a crosslinked, solid IEM reaction product between the plates. A suitable range of film thickness values is 50 μm to 600 μm or 2 μm to 600 μm. For example, an IEM film can have a thickness of at least 2, 5, 10, 15, 20, 30, 50, 75, 100, 125, 150, or 200 μm and/or up to 20, 40, 60, 80, 100, 120, 160, 200, 300, 400, 500, or 600 μm.

In some embodiments, the crosslinked IEM reaction product 150 can be a free-standing film. In other embodiments, the crosslinked IEM reaction product 150 can be adhered or bound to a solid substrate or support material 160, for example to form a backed membrane article 200 as illustrated in FIG. 3. The article 200 can be formed by polymerizing the reaction solution 100 in the presence of the solid support material 160, for example by placing the solid support material 160 along with the reaction solution 100 between the two spaced apart plates as described above. The resulting crosslinked IEM reaction product 150 is thereby adhered to the solid support material 160 once the polymerization is completed. The solid support material 160 is not particularly limited, and it can be selected to impart some additional structural integrity to the IEM 150 in the corresponding backed membrane article 200. Examples of a suitable solid support material 160 include a membrane backing cloth, such as acrylic, polyester, or polypropylene material. The corresponding article 200 is suitable for use as a cation-exchange membrane. In some embodiments and as qualitatively illustrated in FIG. 3, the support 160 can be a continuous (e.g., flat) layer separate or distinct from the IEM 150 layer. In other embodiments, support 160 can have a mesh-like structure or otherwise include openings (e.g., a solid mesh defining square, rectangular, etc. openings) that is embedded within the IEM 150 layer as a reinforcement such as in a composite structure. A suitable range of thickness values for the support material 160 is 50 μm to 600 μm. For example, the support material 160 can have a thickness of at least 50, 75, 100, 125, 150, or 200 μm and/or up to 80, 100, 120, 160, 200, 300, 400, 500, or 600 μm. In embodiments where the support material 160 is embedded within the IEM 150 layer, the corresponding article 200 can have likewise have a net thickness in a range of 50 μm to 600 μm, for example at least 50, 75, 100, 125, 150, or 200 μm and/or up to 80, 100, 120, 160, 200, 300, 400, 500, or 600 μm.

In some embodiments, the crosslinked IEM reaction product can be incorporated into a composite membrane such as a composite IEM. Commercial ion-exchange membranes (IEMs) feature a composite structure. One example is a pore-filled IEM, which is fabricated by polymerizing the ion-exchange polymer within the pores of mechanically strong porous membranes such as microporous membranes. The reason for implementing this composite architecture is twofold. First, the mechanical properties of the membranes can be significantly enhanced relative to those of homogenous membranes, rendering the IEMs suitable for implementation in large scale systems. Second, the swelling of the ion-exchange polymer phase can be physically restricted by the microporous supporting membrane, which can yield composite membranes with fixed charge concentrations that are higher than the homogeneous counterparts. Higher fixed charge concentrations at controlled swelling degrees will yield IEMs with improved selectivity and throughput. Such pore-filled IEMs can be synthesized by thermally polymerizing the charged monomers and cross-linkers within the pores of a microporous membrane. Microporous membranes can be selected to have a desired pore size, porosity, thickness, and/or chemistry depending on the final application. The microporous membranes can be soaked in the reaction solution to allow the reaction solution to fully penetrate the pores of the microporous membranes. After the pore-filling process is complete, the monomer-soaked microporous membranes can be placed on a glass plate or other surface. Excess reaction solution can be gently removed prior to covering the membrane with a second glass plate or other surface. The plates can be placed inside of a forced convection oven or otherwise exposed to sufficient heat to initiate the reaction. The microporous membranes can be microfiltration membranes (e.g., thicknesses of about 100 μm) or battery separator membranes (e.g., thicknesses as low as about 5 μm). A significant advantage of using battery separator membranes is the low membrane thickness, which leads to low electrical resistances of the composite membranes.

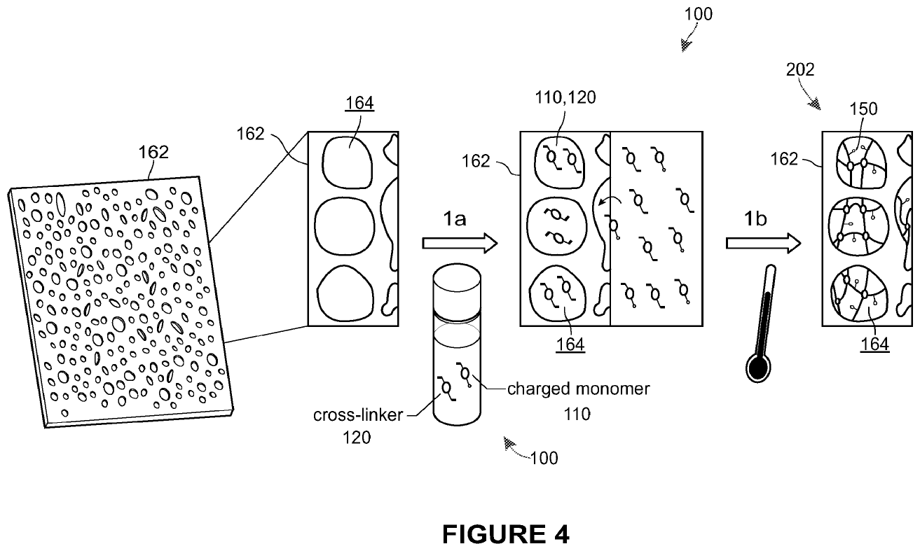

FIG. 4 illustrates a composite membrane article 202 incorporating the crosslinked IEM reaction product 150 as generally described above. The composite membrane article 202 includes a porous substrate 162 with pores 164 therein a particular form of the solid substrate or support discussed above. The crosslinked IEM reaction product 150 is inside the pores 164 of the porous substrate 162 and adhered to the porous substrate at the interior walls or other surfaces of the pores 164. The article 202 can be formed by polymerizing the reaction solution 100 in the presence of the porous substrate 162, for example by immersing or otherwise contacting the porous substrate 162 with the reaction solution 100, which is then absorbed by the porous substrate 162 such that the reaction solution 100 with its reactive components is enters the pores 164. The substrate 162 with the reaction solution 100 absorbed therein can be heated to initiate vinyl polymerization and form the crosslinked IEM reaction product 150. Examples of suitable microporous membranes (or porous membranes more generally) include those with a porosity in a range of 30% to 70%, such as at least 30, 40, 50, or 60% and/or up to 40, 50, 60, or 70%. Alternatively or additionally, the microporous or porous membrane can have a pore size in a range of 0.03 μm to 1 μm, for example at least 0.001, 0.003, 0.01, 0.03, 0.05, 0.07, 0.1, 0.15, 0.2, 0.3, 0.4, or 0.5 μm and/or 0.1, 0.2, 0.3, 0.5, 0.7, or 1 μm. The foregoing pore sizes can represent an average pore size or diameter and/or a range for pore size or diameter distribution (e.g., upper and lower bounds of a cumulative size distribution such as a 1/99%, 5/95%, or 10/90% cut). The material for the membrane is not particularly limited, but examples of suitable membrane materials include polymer materials such as polypropylene, polyethylene, or polytetrafluoroethylene. A suitable range of thickness values for the microporous membrane is 2 μm to 600 μm, such as 2 μm to 20 μm (e.g., for a battery separator) or 50 μm to 200 μm (e.g., for a microfiltration membrane). For example, the porous substrate 162 can have a thickness of at least 2, 5, 10, 15, 20, 30, 50, 75, 100, 125, 150, or 200 μm and/or up to 20, 40, 60, 80, 100, 120, 160, 200, 300, 400, 500, or 600 μm. Similarly, the corresponding article 202 can have likewise have a net thickness of at least 2, 5, 10, 15, 20, 30, 50, 75, 100, 125, 150, or 200 μm and/or up to 20, 40, 60, 80, 100, 120, 160, 200, 300, 400, 500, or 600 μm.

As described above, the crosslinked IEM reaction product 150 has a particularly favorable combination of ionic- and water-based properties making it particularly suitable for use as a membrane or other material in ion-exchange applications. For example, the crosslinked IEM 150 can have high ion-exchange capacity (IEC) values coupled with low water uptake and/or low water mass fraction values. In some embodiments, the crosslinked IEM 150 can have an IEC of at least 1 mmol/g(dry polymer), for example at least 1, 1.2, 1.4, 1.6, 1.8, 2, or 2.4 mmol/g(dry polymer) and/or up to 2, 2.5, 3, 3.5, 4, or 5 mmol/g(dry polymer). In some embodiments, the crosslinked IEM 150 can have a water-uptake of at most 0.7 g(water)/g(dry polymer), for example at least 0.2, 0.25, 0.3, 0.35, 0.4, or 0.45 g(water)/g(dry polymer) and/or up to 0.4, 0.45, 0.5, 0.55, 0.6, 0.65, or 0.7 g(water)/g(dry polymer). In some embodiments, the crosslinked IEM 150 can have a water mass fraction of at most 0.45 g(water)/g(wet polymer), for example at least 0.1, 0.15, 0.2, 0.25, or 0.3 g(water)/g(wet polymer) and/or up to 0.25, 0.3, 0.32, 0.35, 0.38, 0.4, or 0.45 g(water)/g(wet polymer). In some embodiments, the crosslinked IEM 150 can have a ratio of an ion-exchange capacity (IEC) relative to water mass fraction of at least 6 (mmol·g(wet polymer))/(g (dry polymer)·g(water)), for example at least 6, 6.2, 6.5, 6.8, or 7 (mmol·g(wet polymer))/(g (dry polymer)·g(water)) and/or up to 7, 7.2, 7.5, 8, 8.5, 9, or 10 (mmol·g(wet polymer))/(g (dry polymer)·g(water)). In some embodiments, the crosslinked IEM 150 can have a charge concentration of at least 4.5 mmol/g(water), for example at least 4.5, 4.7, 5, or 5.2 mmol/g(water) and/or up to 5, 5.3, 5.7, 6, 6.5, or 7 mmol/g(water). The foregoing properties can be determined using the methods described below in the examples. In particular, the foregoing properties and ranges can represent a hydrated form of the IEM reaction product (e.g., after swelling or soaking in DI water), typically for a sodium counter-ion in charged vinyl monomer repeat units having an anionic group (e.g., sulfonate or carboxylate) and a chloride counter-ion in charged vinyl monomer repeat units having a cationic group (e.g., ammonium). IEM reaction products formed using charged vinyl monomers with counter-ions other than sodium or chloride suitably can be ion-exchanged after polymerization and before property determination. IEM reaction products formed using charged vinyl monomers with sodium or chloride counter-ions can be measured without such an ion-exchange step (e.g., but typically in a hydrated form). In other embodiments, the foregoing properties and ranges can represent a hydrated form of the IEM reaction product with other counter-ions, for example potassium or fluoride (e.g. which might be used for the charged vinyl monomers).

### EXAMPLES

The following examples illustrate the disclosed compositions and methods, but are not intended to limit the scope of any claims thereto. In the following examples, crosslinked ion-exchange materials (IEMs) generally according to the disclosure are prepared in the form of a membrane or film and tested for various properties including ion-exchange capacity (IEC), water uptake, water mass fraction, charge concentration, sodium-form conductivity, and/or sodium chloride permeability.

The crosslinked IEMs can be synthesized via a one-step procedure in which appropriate amounts of charged monomer, cross-linker, solvent, and initiator are mixed to form a clear, homogeneous solution. The solution is placed between glass plates separated by metal spacers (to control thickness) and polymerized by exposure to heat. Industrial manufacturing is similar but employs a roll-to-roll processing. The charge density of the resulting IEM can be controlled by the amount of charged monomer used in the reaction. Water uptake can be controlled by the amount of cross-linker and/or solvent in the reaction. To make highly charged IEMs with low water uptake, large amounts of charged monomer and cross-linker combined are suitably mixed in relatively small amounts of solvent. Other approaches to prepare IEMs have been limited in this aspect, because charged monomers are hydrophilic and cross-linkers are hydrophobic, making it difficult to form highly concentrated solutions of the two monomer components. In contrast to previous approaches, the disclosed reaction solution, in general and as illustrated by the examples below, utilizes charged and crosslinking monomers that together are highly soluble in low amounts of water, which in turn allows the formation of highly charged IEMs that have low water uptake. In a typical reaction, the combined amount of charged monomer and cross-linker can constitute at least 80 wt. % or at least 90 wt. % of the total reaction solution. More specifically, the cross-linkers by themselves are insoluble in water, but are highly soluble in nearly-saturated aqueous solutions of the charged monomer. The disclosed method has several advantages, in addition to its ability to form IEMs with high IEC and low water uptake or water mass fraction, including: (1) use of inexpensive commercially available charged and crosslinking monomers, (2) use of only water as a reaction medium solvent (i.e., a safe and abundant material compared alcohols or other solvents), and (3) ability to use existing industrial infrastructure for scaled-up membrane production.

Experimental Procedures for Material Characterization: The procedures can be used to determine properties of a membrane with or without a backing or other solid support. The example membranes herein did not include a backing or other solid support. All membrane test samples were converted to the sodium counter-ion form prior to any further testing. The conversion process involved immersing the membranes in a 1 molar NaCl solution for at least 24 hours. The NaCl solution was replaced at least three times over this time period to ensure full conversion. The membranes were then immersed in de-ionized water for at least 24 hours to remove any excess salt sorbed in the membrane. The de-ionized water was frequently replaced during this time period. The resulting membrane with a sodium counter-ion and absorbed de-ionized water was used as the starting material for the tests below (referenced as the “hydrated membrane”). Typical membrane samples were about 300 microns in thickness, although, as described below, the determined material properties are independent of the thickness or size of a given test membrane or film. Accordingly, any convenient material thickness or size can be used to determine the following properties, for example a thickness in a range of 50 μm to 600 μm, subrange thereof, or value therein as described above for the IEM film or corresponding backed membrane article containing the IEM film.

In embodiments where the IEM as originally formed already includes a sodium counter-ion for its anionic groups, the above ion-exchange process of soaking in a 1 M NaCl solution can be omitted. For example, if charged vinyl monomers using sodium salts of anionic groups are used to form the IEM, the IEM can be simply immersed in DI water to form the hydrated membrane prior to property determination of the IEM material on a sodium counter-ion basis.

In embodiments where the IEM as originally formed already includes a chloride counter-ion for its cationic groups, the above ion-exchange process of soaking in a 1 M NaCl solution can be omitted. For example, if charged vinyl monomers using chloride salts of cationic groups are used to form the IEM, the IEM can be simply immersed in DI water to form the hydrated membrane prior to property determination of the IEM material on a chloride counter-ion basis.

In embodiments where the IEM as originally formed already includes a counter-ion other than chloride for its cationic groups, the above ion-exchange process of soaking in a 1 M NaCl solution can be performed to replace the original counter-ion with chloride. For example, if charged vinyl monomers using fluoride or other non-chloride salts of cationic groups are used to form the IEM, the IEM can be ion-exchanged in NaCl solution and then immersed in DI water to form the hydrated membrane prior to property determination of the IEM material on a chloride counter-ion basis.

Membrane water uptake and water mass fraction were measured gravimetrically. The surface of a circular hydrated membrane sample (˜2.4 cm in diameter) was quickly and gently blotted using laboratory tissue (e.g., KIMWIPES available from Kimberly-Clark), and the mass of the hydrated sample, m_{wet}, was subsequently recorded. The membrane was then placed in a glass petri dish, and the petri-dish was placed in a vacuum oven at 75° C. to completely dry the membrane. The dry membrane mass, m_{dry}, was periodically recorded until a stable reading was attained (typically within three days). The water uptake (wᵤ) of the membrane was calculated according to Eq. 1 below, and the water mass fraction (wₘ) of the membrane was calculated according to Eq. 2 below.

$${w}_{u} = \frac{{m}_{wet} - {m}_{dry}}{{m}_{dry}} \qquad Eq . 1$$

$${w}_{m} = \frac{{m}_{wet} - {m}_{dry}}{{m}_{wet}} \qquad Eq . 2$$

The ion exchange capacity (IEC) and the fixed charge group concentration (FCC) of the cation exchange membranes were measured via an ashing technique. Circular hydrated membrane samples having a diameter of 2.4 cm were used for the measurements. The thickness and diameter of the hydrated membrane samples were measured. Next, the hydrated membranes were dried in a vacuum oven at 75° C. until a stable dry mass was recorded. The dry membrane samples were placed in a porcelain crucible and ashed at 700° C. for 6 hours in a high temperature furnace. The ash material within the crucibles was then dissolved using a precise volume (typically 15 mL, Vₐ) of a dilute (5 vol %) nitric acid solution. The dissolved ash solution was diluted further (typically 100×), and the cation concentration in the solution (cₐ) was analyzed via elemental analysis techniques (e.g., microwave plasma atomic emission spectrometer). The IEC was calculated using Eq. 3. The FCC in units of mol per gram of water (m_{water}) in the membrane was calculated using Eq. 4.

$$IEC = \frac{{c}_{a} {V}_{a}}{{m}_{dry}} \qquad Eq . 3$$

$$FCC = \frac{{c}_{a} {V}_{a}}{{m}_{water}} = \frac{IEC}{{w}_{u}} \qquad Eq . 4$$

The ionic conductivity was calculated from the electrical resistance of the hydrated membranes measured via electrochemical impedance spectroscopy (EIS). EIS measurements were performed with an in-plane (2 electrodes) cell configuration at ambient conditions (22±1° C.) using a custom sample holder. Rectangular hydrated membrane samples were cut with a 0.8 cm×2 cm rectangular cutting die. The thickness of the membrane samples was measured using a micrometer. Next, the surface of the membrane sample was gently and quickly dried, and the membrane was clamped between the two plates in the sample holder. For the data reported herein, EIS measurements were collected using a potentiostatic control method with an oscillating potential that ranged between 100-750 mV, depending on the sample, over a frequency range of 3 MHz-100 Hz at 10 steps per decade. The ohmic resistance of the membrane (Rₘ) was taken as the diameter of the semicircle in the plots of imaginary vs. real impedance (Nyquist plot). Accurate determination of the semicircle diameter is often obtained by fitting the data to a modified Randles circuit model. The membrane ionic conductivity (δ) was calculated from Eg. 5 below. The cross-sectional area (A) of the membrane was calculated as the product of the membrane sample width and thickness. The length between the electrodes (l) was either 1 cm (inner electrodes) or 1.6 cm (outer electrodes).

$$σ = \frac{l}{A \cdot {R}_{m}} \qquad Eq . 5$$

Salt permeability coefficients were measured using custom-built glass diffusion cells. A hydrated membrane sample previously equilibrated in de-ionized water was clamped between the two half diffusion cells. The downstream chamber was filled with 35 mL of de-ionized water, and a conductivity probe was immersed in the solution. Next, the upstream chamber was filled with 35 mL of a sodium chloride solution (1 M NaCl for the data presented in Table 2). The change in ionic conductivity of the downstream chamber solution over time was monitored using a data collection software connected to the conductivity meter. The downstream solution ionic conductivity was converted to sodium chloride concentration using a calibration curve generated with NIST traceable standard solutions of sodium chloride. The solutions were stirred with magnetic stir bars during the experiment and the temperature was maintained at 22° C. using a circulator bath. The membrane thickness was recorded after the experiment was completed, and the salt permeability coefficient (Pₛ) was calculated via Eq. 5, in which C_{d}^{s}(t) is the salt concentration in the downstream chamber at time t, Cᵤ^{s}(tₒ) is the initial concentration of salt in the upstream cell, V the volume of the upstream and downstream chambers, L is the membrane thickness, and Aₘ is the available area for mass transfer (1.77 cm²).

$$ln ⌊ 1 - \frac{2 {C}_{d}^{s} ( t )}{{C}_{u}^{s} ( {t}_{o} )} ⌋ \cdot ( \frac{VL}{2 {A}_{m}} ) = - {P}_{s} \cdot t \qquad Eq . 6$$

The thickness of a membrane depends on the thickness of the metal spacers that separate the plates between which the reaction solution is placed before polymerization and crosslinking. All of the membranes in the examples herein were synthesized using a 330-micron spacer thickness between plates and without a backing or solid support to provide a free-standing film or membrane. For the low water content membranes, the final thickness of the membranes was usually about 280 microns, and for the medium water content membranes, the final thickness of the membranes was about 310 microns. For all the membranes presented in the examples, the average thickness was about 300 microns. As described above, all material properties are independent of membrane thickness or size.

For example, IEC, ionic conductivity, and salt permeability are normalized by membrane mass, area, or thickness in their determination. Similarly, water uptake and water mass fraction are not functions of membrane thickness or size.

### Example 1

This example illustrates the formation of a crosslinked IEM according to the disclosure. In this example, 3.75 g of 3-sulfopropyl methacrylate potassium salt (SPM; charged vinyl monomer) were dissolved in 1.25 g of deionized water to form a transparent solution. Then, 6 g of glycerol dimethacrylate (GDMA; vinyl crosslinking monomer) were subsequently added to the solution, and the mixture was stirred until it became fully transparent. Next, 0.0975 g (1 wt % of monomer and cross linker) of water-soluble initiator 2,2′-azobis(2-methylpropionamidine)dihydrochloride (commercially known as V-50) were added to the solution, and the mixture was stirred until it became fully transparent (i.e., all components in solution and homogeneously mixed). The solution was placed between two glass plates separated by metal spacers, and the plates were placed in a convection oven at 85° C. for 40 minutes to polymerize the monomer and cross linker. After polymerization, the plates were separated, and the fully transparent membrane samples were placed in deionized water until subsequent characterization. The water was periodically replaced to extract unreacted monomers. The combined mass fraction of charged monomer and cross-linker in the reaction mixture was 0.89. The experimental membrane ion-exchange capacity was 1.38 mmol/g(dry polymer) (theoretical value is 1.56) and the membrane water mass fraction was 0.20.

### Example 2

A similar procedure to that in Example 1 was used to prepare a crosslinked IEM according to the disclosure. The following amounts of reactants and solvent were used: 3.75 g SPM charged monomer, 1.25 g deionized water, 10 g GDMA crosslinking monomer, and 0.1375 g V-50 initiator. The combined mass fraction of charged monomer and cross-linker in the reaction mixture was 0.92. The experimental membrane ion-exchange capacity was 0.96 mmol/g(dry polymer) (theoretical value is 1.1) and the membrane water mass fraction was 0.17.

### Example 3

A similar procedure to that in Example 1 was used to prepare a crosslinked IEM according to the disclosure. The following amounts of reactants and solvent were used: 6.2 g SPM charged monomer, 1.25 g deionized water, 6 g GDMA crosslinking monomer, 0.1375 g V-50 initiator. The mixture was heated at 45 ° C. to facilitate and speed up the dissolution of SPM in water. The combined mass fraction of charged monomer and cross-linker in the reaction mixture was 0.91. The experimental membrane properties were measured: The water uptake was 0.308 g(water)/g(dry polymer), the water mass fraction was 0.236 g(water)/g(hydrated polymer), and the ion-exchange capacity was 1.77 mmol/g(dry polymer). The theoretical ion exchange capacity is 2.06 mmol/g(dry polymer).

### Example 4

A similar procedure to that in Example 1 was used to prepare a variety of different crosslinked IEMs according to the disclosure (denoted as samples 4.1-4.11). Relative amounts of the charged monomer (SPM) and the crosslinking monomer (GDMA) in the reaction solution were varied using a constant level of 1 wt. % initiator (V-50) relative to the combined amount of monomers. The crosslinked IEMs in the form of a membrane or film were tested for IEC, water uptake, water mass fraction, charge concentration, sodium-form conductivity, and sodium chloride permeability. The reaction solution compositions are summarized in Table 1 below, and the property evaluations are summarized in Table 2 below. The results show that the crosslinked IEMs are particularly suitable as membranes based on their high IEC and low water uptake (or low water mass fraction) values, for example as represented by their consistently high charge concentration ranging from about 4.6 to 5.2 in the examples (units: mmol/(g water)) and IEC/water mass fraction ratios ranging from about 6.1 to 7.5 in the examples (units: (mmol·g(wet polymer))/(g (dry polymer)·g(water))).

TABLE 1
Reaction Solution Compositions for Example 4

| | | | | | Concentration (wt. %) | | | | | Ratio |
|---|---|---|---|---|---|---|---|---|---|---|
| | Amounts (g) | | | | | | | | SPM + | SPM: |
| # | SPM | GDMA | Water | V-50 | SPM | GDMA | Water | V-50 | GDMA | GDMA |
| 4.1 | 3.75 | 8 | 1.25 | 0.1175 | 28.6% | 61.0% | 9.53% | 0.90% | 89.6% | 0.469 |
| 4.2 | 3.75 | 7 | 1.25 | 0.1075 | 31.0% | 57.8% | 10.3% | 0.89% | 88.8% | 0.536 |
| 4.3 | 3.75 | 6 | 1.25 | 0.0975 | 33.8% | 54.1% | 11.3% | 0.88% | 87.9% | 0.625 |
| 4.4 | 3.75 | 5 | 1.25 | 0.0875 | 37.2% | 49.6% | 12.4% | 0.87% | 86.7% | 0.750 |
| 4.5 | 3.75 | 4 | 1.25 | 0.0775 | 41.3% | 44.1% | 13.8% | 0.85% | 85.4% | 0.938 |
| 4.6 | 3.75 | 3 | 1.25 | 0.0675 | 46.5% | 37.2% | 15.5% | 0.84% | 83.7% | 1.250 |
| 4.7 | 3.75 | 2 | 1.25 | 0.0575 | 53.1% | 28.3% | 17.7% | 0.81% | 81.5% | 1.875 |
| 4.8 | 5 | 5 | 1.25 | 0.1 | 44.1% | 44.1% | 11.0% | 0.88% | 88.1% | 1.000 |
| 4.9 | 5 | 4 | 1.25 | 0.09 | 48.4% | 38.7% | 12.1% | 0.87% | 87.0% | 1.250 |
| 4.10 | 5 | 3 | 1.25 | 0.08 | 53.6% | 32.2% | 13.4% | 0.86% | 85.7% | 1.667 |
| 4.11 | 5 | 2 | 1.25 | 0.07 | 60.1% | 24.0% | 15.0% | 0.84% | 84.1% | 2.500 |

TABLE 2
IEM Properties for Example 4

| | | | Charge | Charge | | Water | IEC/water | | |
|---|---|---|---|---|---|---|---|---|---|
| | Theoretical | | concen- | concen- | Water | mass | mass | | 1M |
| | IEC | IEC | tration | tration | uptake | fraction | fraction | Sodium-form | NaCl |
| | (mmol/ | (mmol/ | (mmol/mL | (mmol/ | (g water/ | (g water/ | (mmol*g wet)/ | conductivity | permeability |
| # | g dry) | g dry) | membrane) | g water) | g dry) | g wet) | (g dry*g water) | (mS/cm) | (cm²/s) |
| 4.1 | 1.32 | 1.21 | 1.27 | 4.94 | 0.245 | 0.197 | 6.13 | 0.194 | 8.83E−10 |
| 4.2 | 1.45 | 1.30 | 1.35 | 4.92 | 0.265 | 0.209 | 6.23 | 0.336 | 1.05E−09 |
| 4.3 | 1.60 | 1.45 | 1.48 | 5.11 | 0.282 | 0.220 | 6.59 | 0.510 | 1.60E−09 |
| 4.4 | 1.79 | 1.61 | 1.62 | 5.19 | 0.310 | 0.237 | 6.78 | 0.877 | 2.24E−09 |
| 4.5 | 2.03 | 1.83 | 1.77 | 5.11 | 0.358 | 0.264 | 6.93 | 2.000 | 5.02E−09 |
| 4.6 | 2.34 | 2.13 | 1.97 | 5.02 | 0.425 | 0.298 | 7.15 | 3.970 | 1.26E−08 |
| 4.7 | 2.77 | 2.56 | 2.16 | 4.70 | 0.544 | 0.352 | 7.26 | 9.010 | 3.67E−08 |
| 4.8 | 2.10 | 1.89 | 1.87 | 5.36 | 0.352 | 0.260 | 7.25 | 1.550 | 3.37E−09 |
| 4.9 | 2.34 | 2.12 | 2.02 | 5.33 | 0.398 | 0.285 | 7.45 | 2.930 | 6.64E−09 |
| 4.10 | 2.65 | 2.37 | 2.14 | 5.08 | 0.467 | 0.318 | 7.46 | 5.400 | 1.56E−08 |
| 4.11 | 3.04 | 2.77 | 2.27 | 4.62 | 0.599 | 0.375 | 7.38 | 10.250 | 4.72E−08 |

Note:
Values in Table 2 are experimentally determined, other than the theoretical IEC.
The bases “g dry” and “g wet” reflect the mass of dry polymer and the mass of wet (water-containing) polymer, respectively.

Because other modifications and changes varied to fit particular operating requirements and environments will be apparent to those skilled in the art, the disclosure is not considered limited to the example chosen for purposes of illustration, and covers all changes and modifications which do not constitute departures from the true spirit and scope of this disclosure.

Accordingly, the foregoing description is given for clearness of understanding only, and no unnecessary limitations should be understood therefrom, as modifications within the scope of the disclosure may be apparent to those having ordinary skill in the art.

All patents, patent applications, government publications, government regulations, and literature references cited in this specification are hereby incorporated herein by reference in their entirety. In case of conflict, the present description, including definitions, will control.

Throughout the specification, where the compounds, compositions, methods, and processes are described as including components, steps, or materials, it is contemplated that the compositions, processes, or apparatus can also comprise, consist essentially of, or consist of, any combination of the recited components or materials, unless described otherwise. Component concentrations can be expressed in terms of weight concentrations, unless specifically indicated otherwise. Combinations of components are contemplated to include homogeneous and/or heterogeneous mixtures, as would be understood by a person of ordinary skill in the art in view of the foregoing disclosure.

1. A method for forming a crosslinked ion-exchange material (IEM), the method comprising:
providing a reaction solution comprising:
a charged vinyl monomer,
a polyfunctional vinyl crosslinking monomer,
a vinyl polymerization initiator, and
water,
wherein the reaction solution is substantially free from monomer solvents other than water; and
performing vinyl polymerization in the reaction solution between at least the charged vinyl monomer and the polyfunctional vinyl crosslinking monomer, thereby forming a crosslinked ion-exchange material (IEM) reaction product.

2. The method of claim 1, wherein a combined amount of all vinyl monomers and water in the reaction solution is at least 95 wt. % relative to the reaction solution.

3. The method of claim 1, wherein a combined amount of all vinyl monomers in the reaction solution is in a range of 80 wt. % to 95 wt. % relative to the reaction solution.

4. The method of claim 1, wherein:
the charged vinyl monomer is present in the reaction solution in an amount in a range of 40 wt. % to 70 wt. %;
the polyfunctional vinyl crosslinking monomer is present in the reaction solution in an amount in a range of 20 wt. % to 55 wt. %;
a weight ratio of charged vinyl monomer relative to polyfunctional vinyl crosslinking monomer in the reaction solution is in a range of 0.33 to 3.0;
the vinyl polymerization initiator is present in the reaction solution in an amount in a range of 0.01 wt. % to 5 wt. %; and
the water is present in the reaction solution in an amount in a range of 5 wt. % to 25 wt. %.

5. The method of claim 1, wherein the reaction solution contains less than 4 wt. % of monomer solvents other than water.

6. The method of claim 1, wherein the charged vinyl monomer has one polymerizable vinyl group and comprises at least one of a sulfonate group, a carboxylate group, and an ammonium group.

7. The method of claim 1, wherein:
the charged vinyl monomer is represented by formula (I):
R¹—C(═CH₂)—C(═O)—X—R²—Y (I)
R¹ is hydrogen (H) or a hydrocarbon group having 1-4 carbon atoms;
R² is a hydrocarbon group having 1-12 carbon atoms;
X is oxygen (O) or an amino group represented by NR³;
R³ is hydrogen (H) or a hydrocarbon group having 1-4 carbon atoms; and
Y is a charged group selected from the group consisting of a sulfonate group, a carboxylate group, and an ammonium group.

8. The method of claim 1, wherein the polyfunctional vinyl crosslinking monomer has two polymerizable vinyl groups.

9. The method of claim 1, wherein:
the polyfunctional vinyl crosslinking monomer is represented by formula (III):
R¹—C(═CH₂)—C(═O)—X—R²—X—C(═O)—C(═CH₂)—R¹ (III)
R¹ is hydrogen (H) or a hydrocarbon group having 1-4 carbon atoms;
R² is a hydrocarbon group having 1-16 carbon atoms;
X is oxygen (O) or an amino group represented by NR³; and
R³ is hydrogen (H) or a hydrocarbon group having 1-4 carbon atoms.

10. The method of claim 1, wherein the polyfunctional vinyl crosslinking monomer comprises a hydroxy group.

11. The method of claim 1, wherein the vinyl polymerization initiator comprises a free-radical-generating azo compound.

12. The method of claim 1, wherein providing the reaction solution comprises:
providing a pre-solution comprising:
the charged vinyl monomer, and
the water,
wherein the pre-solution is substantially free from monomer solvents other than water; and
adding the polyfunctional vinyl crosslinking monomer and the vinyl polymerization initiator to the pre-solution to form the reaction solution.

13. The method of claim 12, wherein:
the charged vinyl monomer is present in the pre-solution in an amount in a range of 50 wt. % to 90 wt. %;
the water is present in the pre-solution in an amount in a range of 10 wt. % to 50 wt. %;
the pre-solution contains less than 1 wt. % of monomer solvents other than water; and
the pre-solution contains less than 1 wt. % of polyfunctional vinyl crosslinking monomers.

14. The method of claim 12, wherein a combined amount of all vinyl charged monomers and water in the pre-solution is at least 95 wt. % relative to the pre-solution.

15. The method of claim 1, wherein the IEM reaction product is in the form of a thin film.

16. The method of claim 1, further comprising:
performing the vinyl polymerization with the reaction solution in the presence of a solid support material, thereby forming the crosslinked IEM reaction product adhered to the solid support material.

17. The method of claim 16, wherein:
the solid support material comprises a porous substrate defining pores therein; and
the crosslinked IEM reaction product is inside the pores of the porous substrate and adhered to the porous substrate.

18. The method of claim 17, wherein the porous substrate comprises a microporous membrane.

19. The method of claim 17, wherein the microporous membrane has at least one of (i) a porosity in a range of 30% to 70% and (ii) a pore size in a range of 0.03 μm to 1 μm.

20. The method of claim 17, wherein the microporous membrane comprises a polymer selected from the group consisting of polypropylene, polyethylene, polytetrafluoroethylene, and combinations thereof.

21. The method of claim 17, wherein the microporous membrane has a thickness in a range of 2 μm to 20 μm.

22. The method of claim 17, wherein the microporous membrane has a thickness in a range of 50 μm to 200 μm.

23. The method of claim 16, wherein the solid support material has a thickness in a range of 2 μm to 600 μm.

24. The method of claim 1, wherein the crosslinked IEM reaction product has an ion-exchange capacity (IEC) of at least 1 mmol/g(dry polymer).

25. The method of claim 1, wherein the crosslinked IEM reaction product has a water-uptake of at most 0.7 g(water)/g(dry polymer).

26. The method of claim 1, wherein the crosslinked IEM reaction product has a water mass fraction of at most 0.45 g(water)/g(wet polymer).

27. The method of claim 1, wherein the crosslinked IEM reaction has a ratio of an ion-exchange capacity (IEC) relative to water mass fraction of at least 6 (mmol·g(wet polymer))/(g (dry polymer)·g(water)).

28. The method of claim 1, wherein the crosslinked IEM reaction product has a charge concentration of at least 4.5 mmol/g(water).

29. A method for forming a crosslinked ion-exchange material (IEM), the method comprising:
providing a reaction solution comprising:
a charged vinyl monomer,
a polyfunctional vinyl crosslinking monomer,
a vinyl polymerization initiator, and
water,
wherein a combined amount of all vinyl monomers, all vinyl polymerization initiators, and water in the reaction solution is at least 98 wt. % relative to the reaction solution; and
performing vinyl polymerization in the reaction solution between at least the charged vinyl monomer and the polyfunctional vinyl crosslinking monomer, thereby forming a crosslinked ion-exchange material (IEM) reaction product.

30. A crosslinked ion-exchange material (IEM) formed by the method of claim 1.

31. A crosslinked ion-exchange material (IEM) comprising:
a crosslinked reaction product between a charged vinyl monomer and a polyfunctional vinyl crosslinking monomer;
wherein the crosslinked reaction product has at least two of the following properties:
(a) an ion-exchange capacity (IEC) of at least 1 mmol/g(dry polymer);
(b) a water-uptake of at most 0.7 g(water)/g(dry polymer); and
(c) a ratio of an ion-exchange capacity (IEC) relative to water mass fraction of at least 6 (mmol·g(wet polymer))/(g (dry polymer)·g(water)).

32. The crosslinked IEM of claim 31, wherein the crosslinked reaction product has all three of the properties (a), (b), and (c).

33. The crosslinked IEM of claim 31, wherein the crosslinked reaction product further has at least one of the following properties:
(d) a water mass fraction of at most 0.45 g(water)/g(wet polymer); and
(e) a charge concentration of at least 4.5 mmol/g(water).

34. The crosslinked IEM of claim 31, wherein the crosslinked reaction product further has a water mass fraction in a range of 0.1 g(water)/g(wet polymer) to 0.38 g(water)/g(wet polymer).

35. The crosslinked IEM of claim 31, wherein the crosslinked reaction product is in the form of a thin film.

36. A backed membrane article comprising:
a solid support material; and
the crosslinked IEM of claim 35 adhered to the solid support material.

37. An electrodialysis apparatus comprising:
the crosslinked IEM of claim 35.

38. An electrodialysis apparatus comprising:
the backed membrane article of claim 36.

39. A composite membrane article comprising:
a porous substrate defining pores therein; and
the crosslinked IEM of claim 31 inside the pores of the porous substrate and adhered to the porous substrate.

40. The method of claim 1, wherein the polyfunctional vinyl crosslinker is at least one of hydrophobic, water-insoluble, and uncharged.
